(19) United States
(12) Patent Application Publication
(10) Pub. No.: US 2024/0264402 A1
(43) Pub. Date: Aug. 8, 2024

(54) CASSETTE RECEIVING ASSEMBLY CONFIGURED TO PROVIDE ENHANCED ACCESS TO A FIBER OPTIC CASSETTE

(71) Applicant: BELDEN CANADA ULC, SAINT-LAURENT (CA)

(72) Inventors: Lucas RAKOTO-SAM, Montréal (CA); Cristian LEON BUENO, Verdun (CA)

(73) Assignee: BELDEN CANADA ULC, SAINT-LAURENT (CA)

(21) Appl. No.: 18/434,187

(22) Filed: Feb. 6, 2024

Related U.S. Application Data
(60) Provisional application No. 63/443,707, filed on Feb. 6, 2023.

(51) Int. Cl. G02B 6/44

(52) U.S. Cl. CPC G02B 6/44524

(57) ABSTRACT

A cassette receiving assembly may include a mounting portion and a cassette receiving portion structurally configured to receive a fiber optic cassette and to be pivotally coupled with the mounting portion. The cassette receiving portion may include an engagement portion that is configured to be coupled with a coupling portion of the mounting portion, and the coupling portion may be configured to permit the engagement portion to be inserted into and removed from the coupling portion. The coupling portion may be structurally configured to limit a range of rotational movement of the engagement portion relative to the coupling portion so as to limit a range of pivoting movement between the cassette receiving portion and the mounting portion between a first, stowed position and a second, extended position that is configured to provide enhanced access to the cassette relative to the first, stowed position.

### CROSS-REFERENCE TO RELATED APPLICATION

This application claims the benefit of U.S. Provisional Application No. 63/443,707 filed Feb. 6, 2023, pending, the disclosure of which is hereby incorporated by reference herein in its entirety.

### TECHNICAL FIELD

The present disclosure relates to a cassette receiving assembly for a fiber optic cassette and, more particularly, to a cassette receiving portion that is configured to pivot relative to a mounting portion so as to provide enhanced access to the cassette.

### BACKGROUND

Some conventional enclosures for housing a fiber optic cassette include a front and/or a side access panel to permit a technician to access a patch side of the fiber optic cassette for patching fiber optic cable to the fiber optic cassette. However, such conventional enclosures do not permit removal of the fiber optic cassette. Also, such conventional enclosures often include fiber cables that block access to the patch side of the fiber optic cassette.

It may be desirable to provide a cassette receiving assembly that configured to permit the rack to be moved between a first, stowed position and a second, extended position so as to provide enhanced access to the patch side of a fiber optic cassette that is mounted directly to a wall or to a wall of an enclosure. It may be desirable to provide a cassette receiving assembly that is removably detachable to a wall or to a wall of an enclosure. It may be desirable to provide a cassette receiving assembly that limits the range of rotation to provide enhanced fiber routing and maintenance of at least a minimum bend radius.

### SUMMARY

In an exemplary aspect of the disclosure, a cassette receiving assembly may include a mounting portion configured to be attached to a surface and a cassette receiving portion structurally configured to receive a fiber optic cassette. The mounting portion may comprise a first mounting portion and a second mounting portion, and the first mounting portion and the second mounting may be identical. The cassette receiving portion may be configured to be pivotally coupled with and between the first mounting portion and the second mounting portion, and each of the first and second mounting portions may include an attachment portion configured to be attached to the surface and a receiving portion configured to receive the cassette receiving portion. The receiving portion may be configured to include a first coupling portion and a second coupling portion near opposite ends of the receiving portion, and the cassette receiving portion may include a first engagement portion that is configured to be coupled with the first coupling portion of the first mounting portion and a second engagement portion that is configured to be coupled with the second coupling portion of the second mounting portion. Each of the first coupling portion and the second coupling portion may include a first portion fixedly coupled with the receiving portion and a second portion that extends from the first portion, the second portion may include a pair of flexible members that are configured to flex relative to the first portion in a direction toward and away from one another, and the first portion and a portion of the second portion may be configured to form a portion of a circle. The receiving portion may include a wall portion having a notched portion that is configured to receive one of the first engagement portion and the second engagement portion. The cassette receiving portion may include a pair of like guide portions positioned opposite one another in a mirrored relationship and interconnected by a support portion, and the guide portions each may include an outer surface portion facing away from one another, and a first end of each of the guide portions includes one of the first and second engagement portions. The first and second engagement portions each may include a raised portion extending from a respective one of the outer surface portions, and the raised portion may be curved and sized to match and fit in the portion of the circle and may be structurally configured to rotate relative to the receiving portion so as to provide a pivoting relationship between the cassette receiving portion and the mounting portion. The first and second coupling portions may be structurally configured to limit pivoting movement of the cassette receiving portion relative to the respective first and second mounting portions, and the first and second engagement portions and the first and second receiving portions may be configured to permit the rack to be pivotally moved between a first, stowed position and a second, extended position so as to provide enhanced access to the cassette in the second, extended position relative to the first, stowed position.

In some embodiments of the aforementioned cassette receiving assemblies, each of the first coupling portion and the second coupling portion may include a wall portion that extends radially relative to the portion of the circle and may be structurally configured to limit pivotal movement of the cassette receiving portion relative to the respective first and second mounting portions.

In some embodiments of the aforementioned cassette receiving assemblies, the wall portion may be structurally configured to limit pivotal movement of the cassette receiving portion relative to the respective first and second mounting portions to movement between the first, stowed position and the second, extended position.

In an exemplary aspect of the disclosure, a cassette receiving assembly may include a mounting portion and a cassette receiving portion structurally configured to receive a fiber optic cassette and to be pivotally coupled with the mounting portion. The cassette receiving portion may include an engagement portion that is configured to be coupled with a coupling portion of the mounting portion, the coupling portion may include a first portion fixedly coupled with the mounting portion and a second portion that extends from the first portion, and the second portion may be configured to flex so as to permit the engagement portion to be inserted into and removed from the coupling portion. The coupling portion may be structurally configured to limit a range of rotational movement of the engagement portion relative to the coupling portion so as to limit a range of pivoting movement between the cassette receiving portion and the mounting portion. The engagement portion and the coupling portion may be structurally configured to permit the cassette receiving portion to be pivotally moved relative to the mounting portion between a first, stowed position and a second, extended position so as to provide enhanced access to the cassette in the second, extended position relative to the first, stowed position.

In some embodiments of the aforementioned cassette receiving assemblies, the first portion and a portion of the second portion may be configured to form a portion of a circle.

In some embodiments of the aforementioned cassette receiving assemblies, the engagement portion may include a raised portion extending from an outer surface portion of the cassette receiving portion, and the raised portion may be curved and sized to match and fit in the portion of the circle and may be structurally configured to rotate relative to the receiving portion so as to provide the pivoting relationship between the cassette receiving portion and the mounting portion.

In some embodiments of the aforementioned cassette receiving assemblies, the coupling portion may include a wall portion that extends radially relative to the portion of the circle and is structurally configured to limit pivotal movement of the engagement portion relative to the coupling portion.

In some embodiments of the aforementioned cassette receiving assemblies, the wall portion may be structurally configured to limit pivotal movement of the cassette receiving portion relative to the respective first and second mounting portions to movement between the first, stowed position and the second, extended position.

In some embodiments of the aforementioned cassette receiving assemblies, the receiving portion may include a wall portion having a notched portion that is configured to receive the engagement portion.

In some embodiments of the aforementioned cassette receiving assemblies, the cassette receiving portion may include a pair of guide portions positioned opposite one another in a mirrored relationship and interconnected by a support portion, and the guide portions each may include an outer surface portion facing away from one another, and a first end of each of the guide portions may include the engagement portion.

In some embodiments of the aforementioned cassette receiving assemblies, the mounting portion may comprise a first mounting portion and a second mounting portion.

In some embodiments of the aforementioned cassette receiving assemblies, the cassette receiving portion may be configured to be pivotally coupled with and between the first mounting portion and the second mounting portion, and each of the first and second mounting portions may include an attachment portion configured to be attached to the surface and a receiving portion configured to receive the cassette receiving portion.

In some embodiments of the aforementioned cassette receiving assemblies, the coupling portion may comprise a first coupling portion and a second coupling portion, the engagement portion may include a first engagement portion and a second engagement portion, the first engagement portion may be configured to be coupled with the first coupling portion of the first mounting portion, and the second engagement portion may be configured to be coupled with the second coupling portion of the second mounting portion.

In an exemplary aspect of the disclosure, a cassette receiving assembly may include a mounting portion and a cassette receiving portion structurally configured to receive a fiber optic cassette and to be pivotally coupled with the mounting portion. The cassette receiving portion may include an engagement portion that is configured to be coupled with a coupling portion of the mounting portion, and the coupling portion may be configured to permit the engagement portion to be inserted into and removed from the coupling portion. The coupling portion may be structurally configured to limit a range of rotational movement of the engagement portion relative to the coupling portion so as to limit a range of pivoting movement between the cassette receiving portion and the mounting portion between a first, stowed position and a second, extended position that is configured to provide enhanced access to the cassette relative to the first, stowed position.

In some embodiments of the aforementioned cassette receiving assemblies, the coupling portion may include a first portion fixedly coupled with the mounting portion and a second portion that extends from the first portion, and the second portion may be configured to flex so as to permit the engagement portion to be inserted into and removed from the coupling portion.

In some embodiments of the aforementioned cassette receiving assemblies, the first portion and a portion of the second portion may be configured to form a portion of a circle.

In some embodiments of the aforementioned cassette receiving assemblies, the engagement portion may include a raised portion extending from an outer surface portion of the cassette receiving portion, and the raised portion may be curved and sized to match and fit in the portion of the circle and may be structurally configured to rotate relative to the receiving portion so as to provide the pivoting relationship between the cassette receiving portion and the mounting portion.

In some embodiments of the aforementioned cassette receiving assemblies, the coupling portion may include a wall portion that extends radially relative to the portion of the circle and is structurally configured to limit pivotal movement of the engagement portion relative to the coupling portion.

In some embodiments of the aforementioned cassette receiving assemblies, the wall portion may be structurally configured to limit pivotal movement of the cassette receiving portion relative to the respective first and second mounting portions to movement between the first, stowed position and the second, extended position.

In some embodiments of the aforementioned cassette receiving assemblies, the receiving portion may include a wall portion having a notched portion that is configured to receive the engagement portion.

In some embodiments of the aforementioned cassette receiving assemblies, the cassette receiving portion may include a pair of guide portions positioned opposite one another in a mirrored relationship and interconnected by a support portion, and the guide portions each may include an outer surface portion facing away from one another, and a first end of each of the guide portions may include the engagement portion.

In some embodiments of the aforementioned cassette receiving assemblies, the mounting portion may comprise a first mounting portion and a second mounting portion.

In some embodiments of the aforementioned cassette receiving assemblies, the cassette receiving portion may be configured to be pivotally coupled with and between the first mounting portion and the second mounting portion, and each of the first and second mounting portions may include an attachment portion configured to be attached to the surface and a receiving portion configured to receive the cassette receiving portion.

In some embodiments of the aforementioned cassette receiving assemblies, the coupling portion may comprise a first coupling portion and a second coupling portion, the engagement portion may include a first engagement portion and a second engagement portion, the first engagement portion may be configured to be coupled with the first coupling portion of the first mounting portion, and the second engagement portion may be configured to be coupled with the second coupling portion of the second mounting portion.

According to various aspects of the disclosure, an enclosure for receiving fiber optic cassette may include one of the aforementioned embodiments of the cassette receiving assemblies and a housing comprising a cassette receiving space, and the cassette receiving assembly may be configured to be mounted in the housing.

In some embodiment of the enclosure, the cassette receiving space may be defined by a rear wall, a top wall, a bottom wall opposite the top wall, and a pair of opposed sidewalls positioned between the top wall and the bottom wall, and respective forwards edges of the top wall, the bottom wall, and the sidewalls are configured to define an opening to the cassette receiving space opposite the rear wall.

Various aspects of the seal assembly, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is an exploded perspective view of an exemplary cassette receiving assembly according to various aspects of the disclosure.

FIG. 2 is an enlarged side view of a portion of the cassette receiving assembly of FIG. 1.

FIG. 3 is an enlarged perspective view of a portion of the cassette receiving assembly of FIG. 1 in a pre-assembled configuration.

FIG. 4 is an enlarged perspective view of a portion of the cassette receiving assembly of FIG. 1 in a first partially assembled configuration.

FIG. 5 is an enlarged perspective view of a portion of the cassette receiving assembly of FIG. 1 in a second partially assembled configuration.

FIG. 6 is an enlarged perspective view of a portion of the cassette receiving assembly of FIG. 1 in an assembled configuration.

FIG. 7 is a diagram illustrating the range of rotation of the cassette receiving assembly of FIG. 1.

FIG. 8 is an exploded perspective view of an exemplary enclosure that includes the cassette receiving assembly of FIG. 1.

FIG. 9 is a first perspective view of the exemplary enclosure of FIG. 8 that includes the cassette receiving assembly of FIG. 1 in a stowed position.

FIG. 10 is an enlarged second perspective view of the enclosure of FIG. 8 that includes the cassette receiving assembly of FIG. 1 in a stowed position.

FIG. 11 is a first perspective view of the enclosure of FIG. 8 that includes the cassette receiving assembly of FIG. 1 in an extended position.

FIG. 12 is a second perspective view of the enclosure of FIG. 8 that includes the cassette receiving assembly of FIG. 1 in an extended position.

FIG. 13 is a third perspective view of the enclosure of FIG. 8 that includes the cassette receiving assembly of FIG. 1 and an exemplary fiber optic cassette in an extended position.

FIG. 14 is a perspective view of the enclosure of FIG. 8 is a closed configuration.

### DETAILED DESCRIPTION

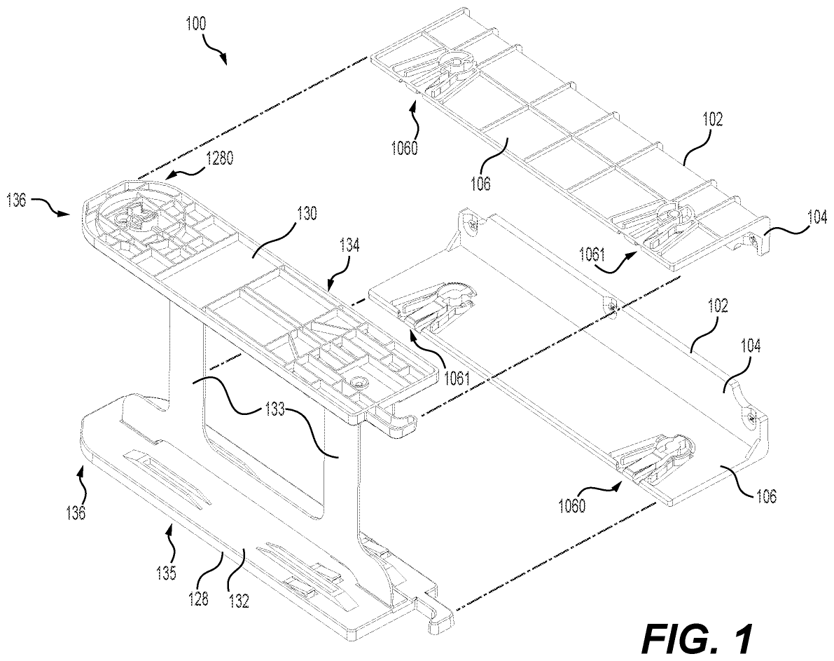

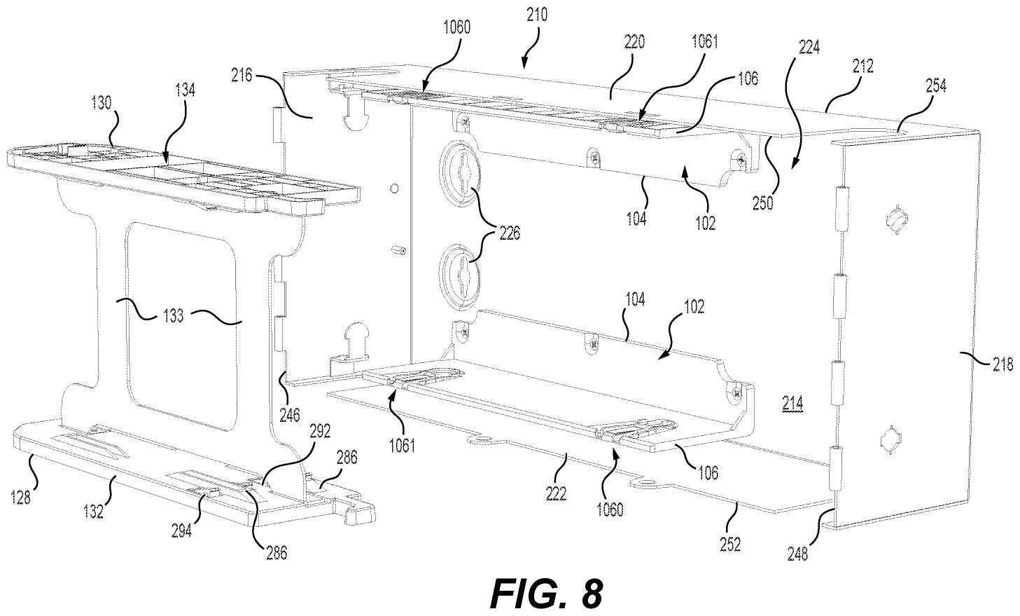

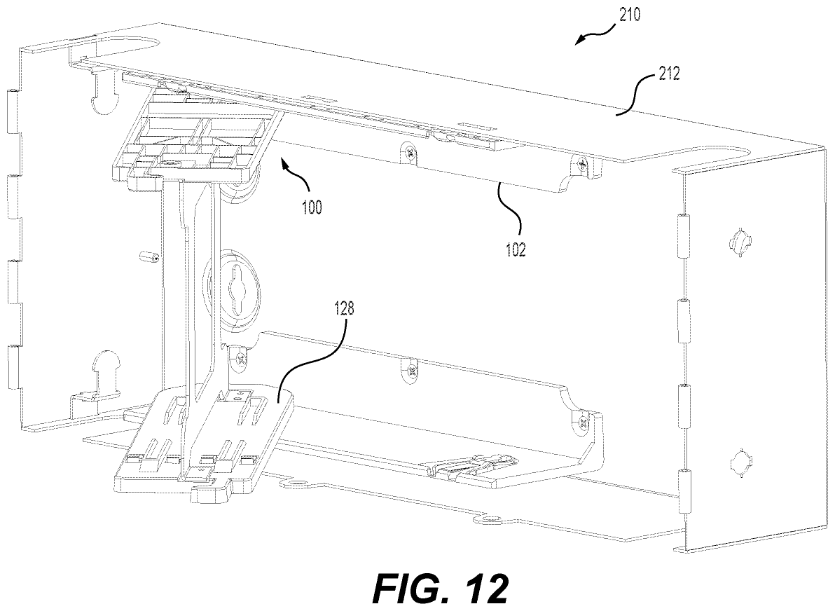

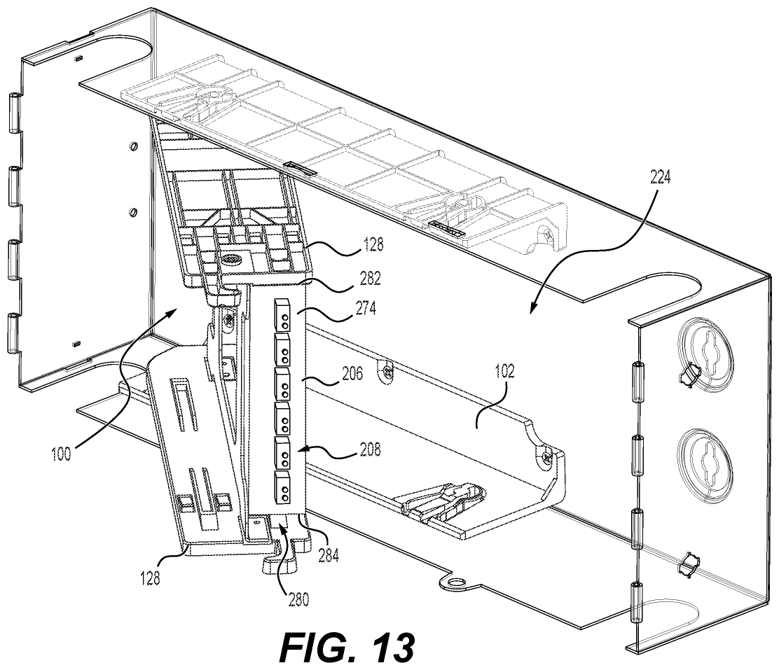

FIGS. 1-7 illustrate an exemplary cassette receiving assembly 100 for a for fiber optic cassettes. The cassette receiving assembly 100 includes a mounting portion 102, for example, two mounting structures or brackets, and a cassette receiving portion 128, for example, a rack, configured to receive at least one fiber optic cassette. The rack 128 is configured to be pivotally mounted to the mounting structures 102, as described in more detail below. In some aspects, the cassette receiving assembly 100 may be mounted to an enclosure 10, as illustrated in FIGS. 8-14.

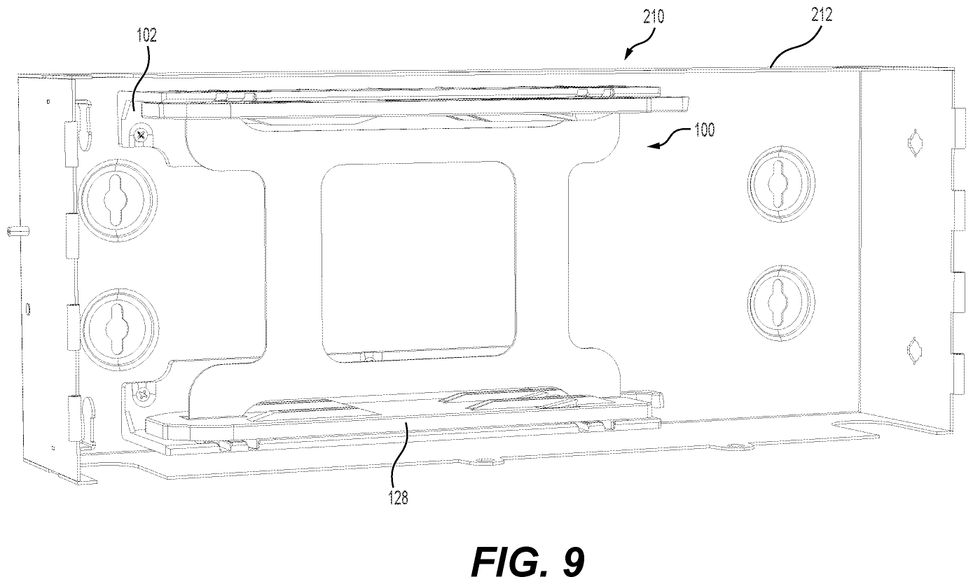

Referring now to FIG. 1, each mounting structure 102 includes an attachment portion 104 and a receiving portion 106. The attachment portion 104 is configured to be attached to a surface, for example, a wall, an enclosure, or the like. The receiving portion 106 includes a first receiving portion or first receiving structure 1060 and a second receiving portion or first receiving structure 1061 near opposite ends of the receiving portion 106. The rack 128 includes a first engagement portion or first engagement structure 1280 and a second engagement portion or first engagement structure 1281 (FIGS. 9-11). While only the first receiving structure 1060 is described in detail below, it should be understood that the second receiving structure 1061 is a mirror image of the first receiving structure 1060, which will become more apparent from such description. While only the first engagement structure 1280 is described in detail below, it should be understood that the second engagement structure 1281 is a mirror image of the first engagement structure 1280, which will become more apparent from such description.

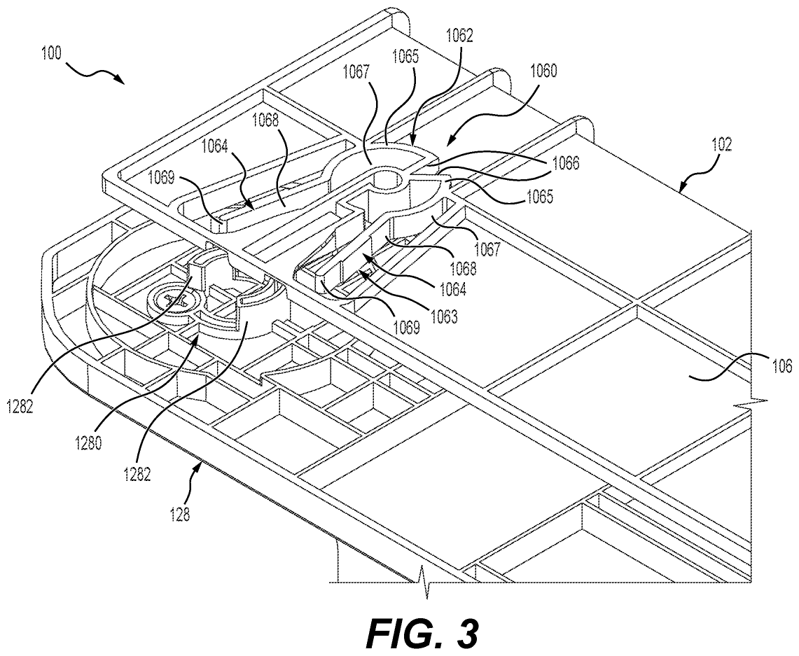

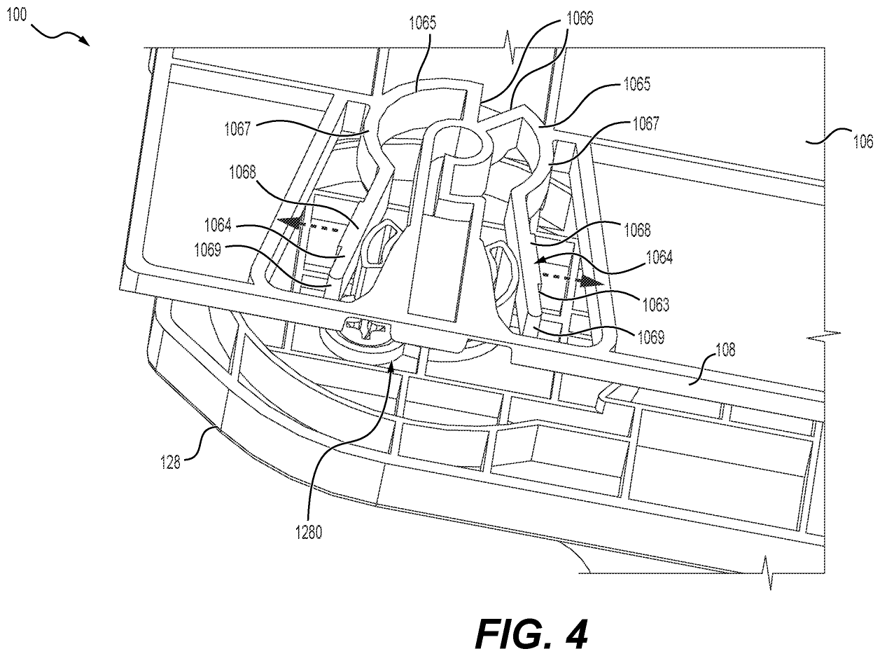

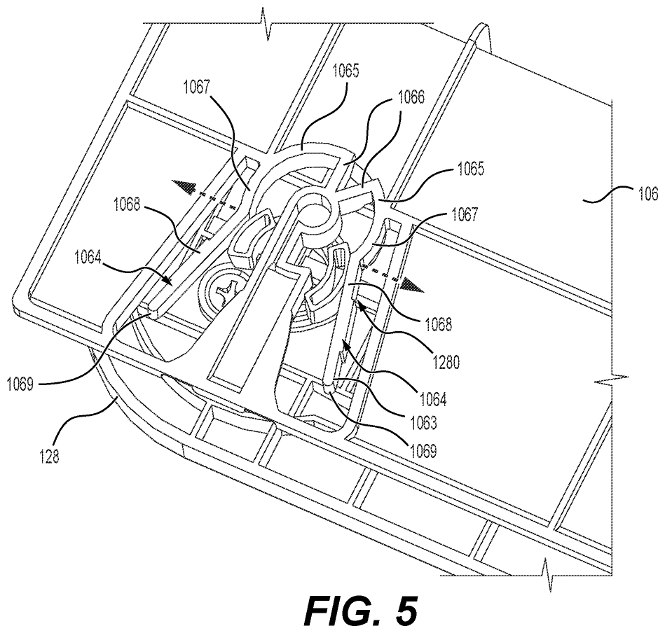

As best shown in FIGS. 3-6, the first receiving structure 1060 includes a first portion 1062 fixedly coupled with the receiving portion 106 and a second portion 1063 that extends from the first portion 1062. The second portion 1063 may include a pair of flexible portion or flexible members 1064, for example, flexible fingers, that are configured to flex relative to the first portion 1062 in a direction toward and away from one another, as indicated by the arrows in FIGS. 4 and 5. The first portion 1062 includes a curved portion 1065 that is configured to form a portion of a circle and a radial portion 1066.

In the exemplary embodiment illustrated in FIGS. 4-6, the curved portion 1065 includes two curved portions separated by a space along a circumference of the circle, and the radial portion 1066 includes two radial portions extending radially inward from the two curved portions. In the illustrated embodiment, each of the flexible members 1064 includes a curved portion 1067 and a straight portion 1068. The curved portion 1067 extends from the curved portion 1065 of the first portion 1062, and the straight portion 1068 extends from the curved portion 1067 to a free end portion 1069.

In the illustrated embodiment, the receiving portion 106 includes a wall 108 spaced from the free ends 1069 of the flexible members 1064. The wall 108 includes a notched portion 109 configured to receive the first engagement structure 1280 or the second engagement structure 1281, as will be discussed in more detail below. In the illustrated embodiment, the notched portion 109 includes two spaced apart notches, but it should be understood that the notched portion 109 may include a single continuous notch in some embodiments.

As shown in FIGS. 3-6, the rack 128 includes a guide portion, for example, a pair of like guide members 130, 132, positioned opposite one another in a mirrored relationship and interconnected by a support portion 133, for example, a pair of support members, as shown in the exemplary embodiment. The guide members 130, 132 each include an outer surface 134, 135 facing away from one another. A first end portion 136 of each of the guide members 130, 132 includes one of the first and second engagement structures 1280, 1281. For example, the first and second engagement structures 1280, 1281 may include a raised portion 1282 extending from a respective one of the outer surfaces 134, 135. In some aspects, the raised portion 1282 may include two raised portions, as shown. The raised portion 1282 may be solid or hollow. The raised portion 1282 may be curved and sized to match and fit in the circle formed by the curved portions 1065, 1067 of the receiving portion 106. As a result, the raised portion 1282 may be configured to rotate in the receiving portion 106 so as to provide a pivoting relationship between the rack 128 and the mounting structure 102.

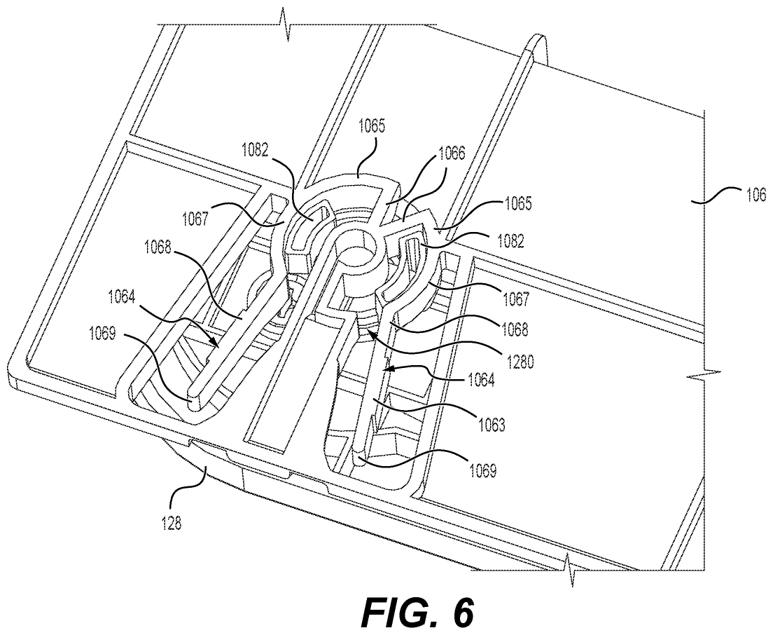

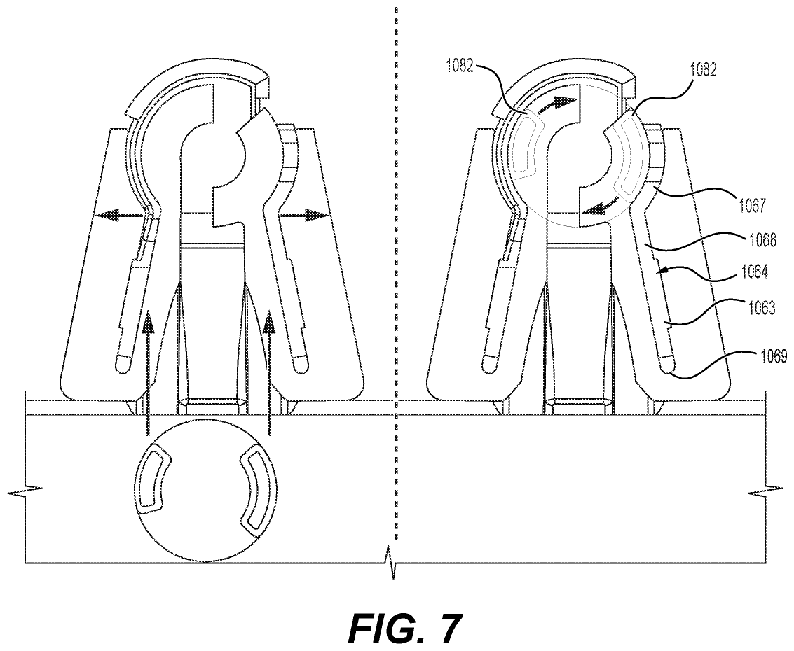

Referring now to FIGS. 6 and 7, the radial portion 1066, for example, the two radial portions cooperate with the raised portion 1282, for example, the two raised portions, to limit the clockwise and counterclockwise rotation of the rack 128 relative to the mounting structures 102. For example, in some aspects, the radial portion 1066 and the raised portion 1282 may limit rotation of the rack 128 relative to the mounting structures 102 between the stowed position and an extended position where the rack 128 extends at a 45 degree angle relative to the mounting structures 102. Of course, it should be understood that the radial portion 1066 and the raised portion 1282 may be configured to limit rotation of the rack 128 relative to the mounting structures 102 to any desired angle. Alternatively, the radial portion 1066 and the raised portion 1282 may be configured so as to not limit rotation of the rack 128 relative to the mounting structures 102 to any angle, but instead to permit a freely rotating pivot point.

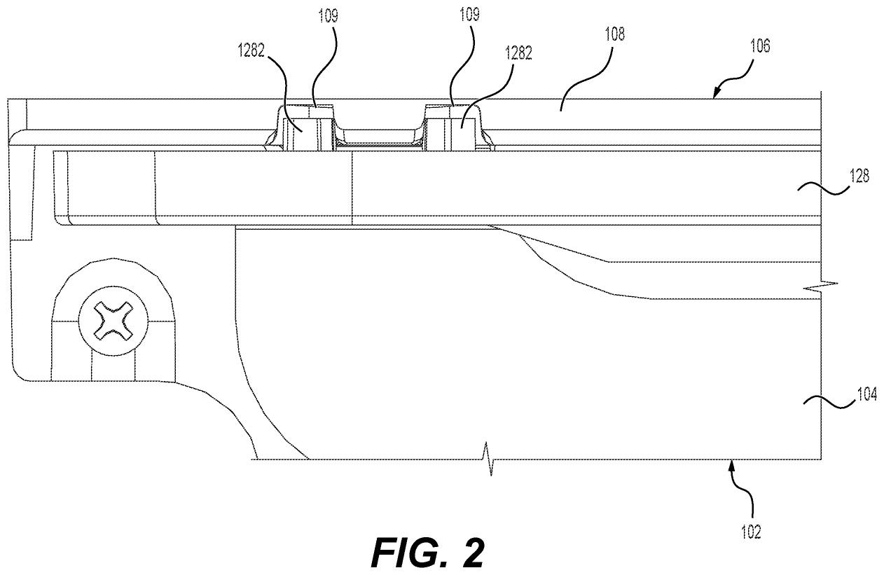

Referring again to FIG. 1, to couple the rack 128 with the two mounting structures 102, the mounting structures are mounted to a surface (not shown) and spaced apart by a distance that permits the first and second engagement structures 1280, 1281 of the rack 128 to be received by the receiving portions 106 of the spaced apart mounting structures 102. As shown in FIGS. 2 and 3, the raised portion 1282 of the first engagement structure 1280 is aligned with the notched portion 109 of the wall 108 of one of the mounting structures 102. The same alignment is performed for the second engagement structure 1281 and a second one of the mounting structures 102. As shown in FIG. 4, as the first engagement structure 1280 is inserted further into the first receiving structure 1060, the raised portion 1282 of the first engagement structure 1280 engages the straight portions 1068 of the flexible members 1064 and begins to urge the flexible members 1064 away from one another. As shown in FIG. 5, as the first engagement structure 1280 is inserted into the first receiving structure 1060 to the point where the straight portions 1068 of the flexible members 1064 meet the curved portions 1067, the raised portion 1282 of the first engagement structure 1280 urges the flexible members 1064 away from one another sufficiently far enough to permit the raised portion 1282 to be received in the circular opening formed by the curved portions 1065, 1067. After the raised portion 1282 to be received in the circular opening, the flexible members 1064 are biased back toward their rest position to maintain the raised portion 1282 in the circular opening, thereby coupling the rack 128 to the mounting structure 102 while permitting rotation of the rack 128 relative to the mounting structure 102. The second engagement structure 1281 is similarly inserted into the second receiving structure 1061 of the other mounting structure 102. In order to remove the rack 128 from the mounting structure 102, the rack is pulled away from the respective receiving structure 1061, 1062 using a force that is sufficient to bend the flexible members 1064 away from one another by a distance that permits the raised portion 1282 to be removed from the circular opening formed by the curved portions 1065, 1067.

It should be understood that the first engagement structure 1280 can be inserted into either the first receiving structure 1061 or the second receiving structure 1062 of one of the mounting structures 102. When the first engagement structure 1280 is inserted into the first receiving structure 1061 of one of the mounting structures, the second engagement structure 1062 is inserted into the second receiving structure 1062 of the other one of the mounting structures 102. Conversely, when the first engagement structure 1261 is inserted into the second receiving structure 1062 of one of the mounting structures, the second engagement structure 1062 is inserted into the first receiving structure 1061 of the other one of the mounting structures 102.

Referring now to FIGS. 8-13, in some embodiments, the mounting structures 102 may be mounted within an enclosure 210. The enclosure may include a housing 212 having a rear wall 214, two opposed side walls 216, 218, and an opposed top wall 220 and bottom wall 222 which together define a cassette receiving space 224. For example, one of the mounting structures 102 may be mounted to the top wall, and the other one of the mounting structures 104 may be mounted to the bottom wall. The rear wall 214 may include features, such as keyhole slots 226, that allow the enclosure 210 to be readily mounted to a wall or the like (not shown), for example by using screws (also not shown) or another appropriate type of fastener.

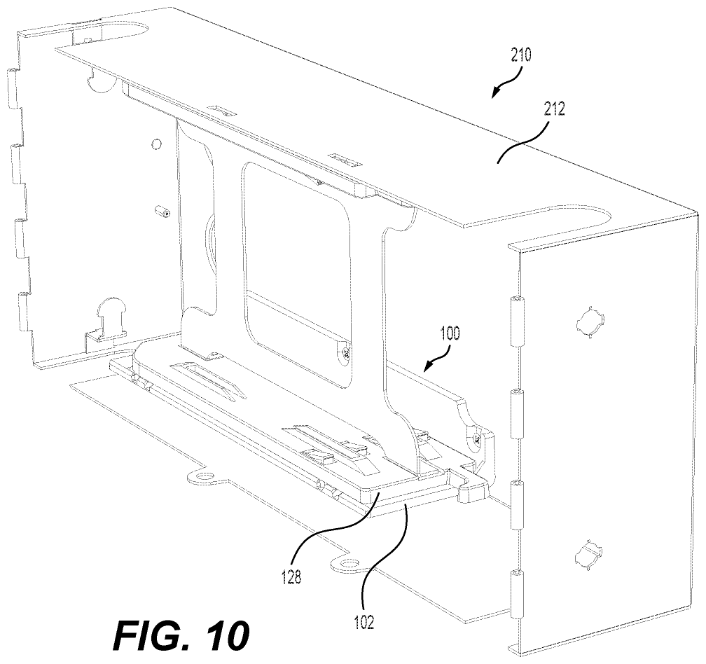

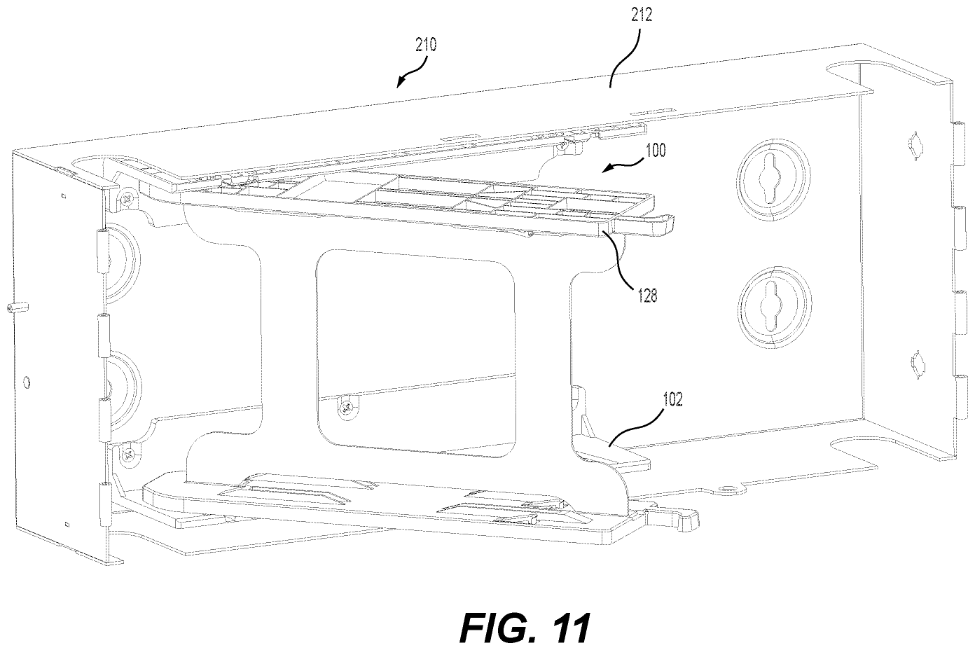

The rack 128 may be received in the cassette receiving space 224 between the top wall 220 and the bottom wall 222 for rotation about a pivot axis X formed by the receiving structures 1061, 1062 and the engagement structures 1280, 1281 such that the rack 128 can be rotated between a first position (i.e., a closed or stowed position), as illustrated in FIGS. 9 and 10, where the rack 128 is received entirely within the cassette receiving space 124, and a second position (i.e., an open or extended position), as illustrated in FIGS. 11-13, where a second end of the rack 128 is positioned outside the cassette receiving space 224 such that, as will be discussed in more detail below, the fiber optic cassettes can be inserted into or removed from the rack 128. It should be understood that the rack 128 may be held in place in the first position and/or the second position by a frictional relationship between the guide members 130, 132 and the receiving portion 106 of the mounting structures 102.

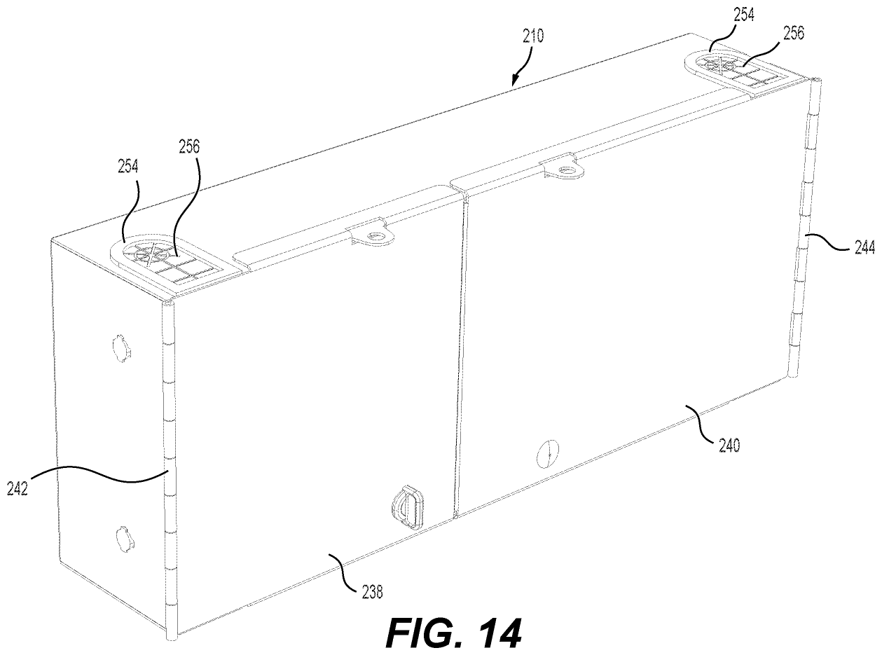

Referring to FIG. 14, the enclosure may include first and second doors 238, 240. Each door 238, 240 may include a respective outer hinged edge 242, 244 adjacent a forward edge 246, 248 of a respective one of the sidewalls 216, 218. The doors 238, 240 are hinged for movement between an open position, wherein the cassette receiving space 224 is accessible, and a closed position wherein the doors 238, 240 are positioned in front of the opening defined by forward edges 246, 248 of the sidewalls 216, 218, a forward edge 250 of the top wall 220, and a forward edge 252 of the bottom wall 222. The housing 212 may include one or more cutaways 254 for running optic fibers (not shown) or the like in and out of the housing 212 when the doors 238, 240 are in the closed position. The cutaways 254 may be sealed for example by a grommet or gasket 256. Other features, such as cable tie downs (not shown) may also be provided to facilitate cable management.

As discussed above the rack 128 is configured to receive a pair of fiber optic cassettes 274. In order to remove or insert a fiber optic cassette 274 from/into the rack 128, the rack 128 is rotated from the closed position (FIGS. 9 and 10) to the open position (FIGS. 11-13) about pivot axis X formed by the receiving structures 1061, 1062 and the engagement structures 1280, 1281. Provision of the rotatable rack 128 may permit relatively long fiber optic cassettes 274 to be readily inserted and removed from the cassette receiving space 224 while still providing for a wall mount enclosure with a limited raised profile. Each cassette 274 may include a pair of elongate rail receiving grooves 280 on a top side 282 and bottom side 284 thereof. The rail receiving grooves 280 slidingly receive a respective rail 286 in each of the guide members 130, 132. The cassette 274 is slid into the rack 128 and on reaching an installed position a latch 288, 290 in the cassette 274 engages respective tabs 292, 294 in each of the guide members 130, 132, thereby securing the cassette 274 in the rack 128. With cassettes 274 in the installed position, the rack 128 can be returned to the closed position, allowing, for example, the doors 238, 240 to be shut. In some aspects, the cassettes 274 may be reversible and may be installed in a back to front direction, or upside down.

Each fiber optic cassette 274 may comprise a housing 206 for receiving a plurality of optic fibers (not shown) which interconnect one or more optic fibers terminated on a first face 208 of the fiber optic cassette 274 with one or more optic fibers terminated on a second face 210 of the fiber optic cassette 274. In this regard, a plurality of adaptors 212 can be provided which illustratively receive a standardized optic fiber cable plug, such as an LC type fiber optic plug (not shown). Features such as cable supports around which fiber optic cables can be wound or cable tie downs may also be provided to facilitate arrangement of optic fibers within the cassette 274. Additionally, one or more break away portions may be provided allowing for one or more optic fibers to exit the housing. The fiber optic cassette 274 may include a removable cover to simplify access to the inside of the housing 206.

It should be appreciated that, in some embodiments, multiple pairs of mounting structures 102 may be arranged and configured to receive multiple racks 128 in a stacked arrangement. The multiple pairs of mounting structures 102 and multiple racks 128 may be mounted in an enclosure or may be mounted directly to a wall. In such a stacked arrangement, the multiple racks may be independently rotatable between the closed or stowed position and the open or extended position.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A cassette receiving assembly configured to permit a fiber optic cassette to be moved between a first position and a second position that provides enhanced access to the cassette relative to the first position, comprising:
a mounting portion configured to be attached to a surface;
a cassette receiving portion structurally configured to receive a fiber optic cassette;
wherein the mounting portion comprises a first mounting portion and a second mounting portion;
wherein the first mounting portion and the second mounting are identical;
wherein the cassette receiving portion is configured to be pivotally coupled with and between the first mounting portion and the second mounting portion;
wherein each of the first and second mounting portions includes an attachment portion configured to be attached to the surface and a receiving portion configured to receive the cassette receiving portion;
wherein the receiving portion is configured to include a first coupling portion and a second coupling portion near opposite ends of the receiving portion;
wherein the cassette receiving portion includes a first engagement portion that is configured to be coupled with the first coupling portion of the first mounting portion and a second engagement portion that is configured to be coupled with the second coupling portion of the second mounting portion;
wherein each of the first coupling portion and the second coupling portion includes a first portion fixedly coupled with the receiving portion and a second portion that extends from the first portion;
wherein the second portion includes a pair of flexible members that are configured to flex relative to the first portion in a direction toward and away from one another;
wherein the first portion and a portion of the second portion are configured to form a portion of a circle;
wherein the receiving portion includes a wall portion having a notched portion that is configured to receive one of the first engagement portion and the second engagement portion;
wherein the cassette receiving portion includes a pair of like guide portions positioned opposite one another in a mirrored relationship and interconnected by a support portion;
wherein the guide portions each include an outer surface portion facing away from one another, and a first end of each of the guide portions includes one of the first and second engagement portions;
wherein the first and second engagement portions each include a raised portion extending from a respective one of the outer surface portions;
wherein the raised portion is curved and sized to match and fit in the portion of the circle and is structurally configured to rotate relative to the receiving portion so as to provide a pivoting relationship between the cassette receiving portion and the mounting portion;
wherein the first and second coupling portions are structurally configured to limit pivoting movement of the cassette receiving portion relative to the respective first and second mounting portions; and
wherein the first and second engagement portions and the first and second receiving portions are configured to permit the rack to be pivotally moved between a first, stowed position and a second, extended position so as to provide enhanced access to the cassette in the second, extended position relative to the first, stowed position.

2. The cassette receiving assembly of claim 1, wherein each of the first coupling portion and the second coupling portion includes a wall portion that extends radially relative to the portion of the circle and is structurally configured to limit pivotal movement of the cassette receiving portion relative to the respective first and second mounting portions.

3. The cassette receiving assembly of claim 1, wherein the wall portion is structurally configured to limit pivotal movement of the cassette receiving portion relative to the respective first and second mounting portions to movement between the first, stowed position and the second, extended position.

4. An enclosure for receiving a fiber optic cassette comprising:
the cassette receiving assembly of claim 1;
a housing comprising a cassette receiving space; and
wherein the cassette receiving assembly is configured to be mounted in the housing.

5. The enclosure of claim 4, wherein the cassette receiving space is defined by a rear wall, a top wall, a bottom wall opposite the top wall, and a pair of opposed sidewalls positioned between the top wall and the bottom wall; and
wherein respective forwards edges of the top wall, the bottom wall, and the sidewalls are configured to define an opening to the cassette receiving space opposite the rear wall.

6. A cassette receiving assembly configured to permit a fiber optic cassette to be moved between a first position and a second position that provides enhanced access to the cassette relative to the first position, comprising:
a mounting portion;
a cassette receiving portion structurally configured to receive a fiber optic cassette and to be pivotally coupled with the mounting portion;
wherein the cassette receiving portion includes an engagement portion that is configured to be coupled with a coupling portion of the mounting portion;
wherein the coupling portion includes a first portion fixedly coupled with the mounting portion and a second portion that extends from the first portion;
wherein the second portion is configured to flex so as to permit the engagement portion to be inserted into and removed from the coupling portion;
wherein the coupling portion is structurally configured to limit a range of rotational movement of the engagement portion relative to the coupling portion so as to limit a range of pivoting movement between the cassette receiving portion and the mounting portion; and
wherein the engagement portion and the coupling portion are structurally configured to permit the cassette receiving portion to be pivotally moved relative to the mounting portion between a first, stowed position and a second, extended position so as to provide enhanced access to the cassette in the second, extended position relative to the first, stowed position.

7. The cassette receiving assembly of claim 6, wherein the first portion and a portion of the second portion are configured to form a portion of a circle;
wherein the engagement portion includes a raised portion extending from an outer surface portion of the cassette receiving portion; and
wherein the raised portion is curved and sized to match and fit in the portion of the circle and is structurally configured to rotate relative to the receiving portion so as to provide the pivoting relationship between the cassette receiving portion and the mounting portion.

8. The cassette receiving assembly of claim 7, wherein the coupling portion includes a wall portion that extends radially relative to the portion of the circle and is structurally configured to limit pivotal movement of the engagement portion relative to the coupling portion.

9. The cassette receiving assembly of claim 8, wherein the wall portion is structurally configured to limit pivotal movement of the cassette receiving portion relative to the respective first and second mounting portions to movement between the first, stowed position and the second, extended position.

10. The cassette receiving assembly of claim 6, wherein the receiving portion includes a wall portion having a notched portion that is configured to receive the engagement portion.

11. The cassette receiving assembly of claim 6, wherein the cassette receiving portion includes a pair of guide portions positioned opposite one another in a mirrored relationship and interconnected by a support portion;
wherein the guide portions each include an outer surface portion facing away from one another, and a first end of each of the guide portions includes the engagement portion.

12. The cassette receiving assembly of claim 6, wherein the mounting portion comprises a first mounting portion and a second mounting portion;
wherein the cassette receiving portion is configured to be pivotally coupled with and between the first mounting portion and the second mounting portion; and
wherein each of the first and second mounting portions includes an attachment portion configured to be attached to the surface and a receiving portion configured to receive the cassette receiving portion.

13. The cassette receiving assembly of claim 12, wherein the coupling portion comprises a first coupling portion and a second coupling portion;
wherein the engagement portion including a first engagement portion and a second engagement portion; and
wherein the first engagement portion is configured to be coupled with the first coupling portion of the first mounting portion and the second engagement portion is configured to be coupled with the second coupling portion of the second

14. An enclosure for receiving a fiber optic cassette comprising:
the cassette receiving assembly of claim 6;
a housing comprising a cassette receiving space; and
wherein the cassette receiving assembly is configured to be mounted in the housing.

15. The enclosure of claim 14, wherein the cassette receiving space is defined by a rear wall, a top wall, a bottom wall opposite the top wall, and a pair of opposed sidewalls positioned between the top wall and the bottom wall; and
wherein respective forwards edges of the top wall, the bottom wall, and the sidewalls are configured to define an opening to the cassette receiving space opposite the rear wall.

16. A cassette receiving assembly configured to permit a fiber optic cassette to be moved between a first position and a second position that provides enhanced access to the cassette relative to the first position, comprising:
a mounting portion;
a cassette receiving portion structurally configured to receive a fiber optic cassette and to be pivotally coupled with the mounting portion;
wherein the cassette receiving portion includes an engagement portion that is configured to be coupled with a coupling portion of the mounting portion;
wherein the coupling portion is configured to permit the engagement portion to be inserted into and removed from the coupling portion;
wherein the coupling portion is structurally configured to limit a range of rotational movement of the engagement portion relative to the coupling portion so as to limit a range of pivoting movement between the cassette receiving portion and the mounting portion between a first, stowed position and a second, extended position that is configured to provide enhanced access to the cassette relative to the first, stowed position.

17. The cassette receiving assembly of claim 16, wherein the coupling portion includes a first portion fixedly coupled with the mounting portion and a second portion that extends from the first portion; and
wherein the second portion is configured to flex so as to permit the engagement portion to be inserted into and removed from the coupling portion.

18. The cassette receiving assembly of claim 16, wherein the first portion and a portion of the second portion are configured to form a portion of a circle;
wherein the engagement portion includes a raised portion extending from an outer surface portion of the cassette receiving portion; and
wherein the raised portion is curved and sized to match and fit in the portion of the circle and is structurally configured to rotate relative to the receiving portion so as to provide the pivoting relationship between the cassette receiving portion and the mounting portion.

19. The cassette receiving assembly of claim 18, wherein the coupling portion includes a wall portion that extends radially relative to the portion of the circle and is structurally configured to limit pivotal movement of the engagement portion relative to the coupling portion.

20. The cassette receiving assembly of claim 19, wherein the wall portion is structurally configured to limit pivotal movement of the cassette receiving portion relative to the respective first and second mounting portions to movement between the first, stowed position and the second, extended position.

21. The cassette receiving assembly of claim 16, wherein the receiving portion includes a wall portion having a notched portion that is configured to receive the engagement portion.

22. The cassette receiving assembly of claim 16, wherein the cassette receiving portion includes a pair of guide portions positioned opposite one another in a mirrored relationship and interconnected by a support portion;
wherein the guide portions each include an outer surface portion facing away from one another, and a first end of each of the guide portions includes the engagement portion.

23. The cassette receiving assembly of claim 16, wherein the mounting portion comprises a first mounting portion and a second mounting portion;
wherein the cassette receiving portion is configured to be pivotally coupled with and between the first mounting portion and the second mounting portion; and
wherein each of the first and second mounting portions includes an attachment portion configured to be attached to the surface and a receiving portion configured to receive the cassette receiving portion.

24. The cassette receiving assembly of claim 23, wherein the coupling portion comprises a first coupling portion and a second coupling portion;
wherein the engagement portion including a first engagement portion and a second engagement portion; and
wherein the first engagement portion is configured to be coupled with the first coupling portion of the first mounting portion and the second engagement portion is configured to be coupled with the second coupling portion of the second

25. An enclosure for receiving a fiber optic cassette comprising:
the cassette receiving assembly of claim 16;
a housing comprising a cassette receiving space; and
wherein the cassette receiving assembly is configured to be mounted in the housing.

26. The enclosure of claim 25, wherein the cassette receiving space is defined by a rear wall, a top wall, a bottom wall opposite the top wall, and a pair of opposed sidewalls positioned between the top wall and the bottom wall; and
wherein respective forwards edges of the top wall, the bottom wall, and the sidewalls are configured to define an opening to the cassette receiving space opposite the rear wall.
